(19) United States
(12) Patent Application Publication
(10) Pub. No.: US 2002/0155893 A1
(43) Pub. Date: Oct. 24, 2002

(54) Computerized trading card system

(76) Inventors: Arthur Swanberg, Westport, CT (US); Ethan Rappaport, Orange, CT (US)

Correspondence Address: Drinker Biddle & Reath, LLP, One Logan Square, 18th and Cherry Sts., Philadelphia, PA, 19103-6996, US

(21) Appl. No.: 10/103,410

(22) Filed: Mar. 21, 2002

Related U.S. Application Data
(63) Continuation-in-part of application No. 09/472,042, filed on Dec. 27, 1999.

(51) Int. Cl. A63F 13/00

(52) U.S. Cl. 463/43

(57) ABSTRACT

A system for playing a game using read/writable media is disclosed. The game comprises an entity having several components, and each piece of media has data stored thereon the represents one or more components and/or properties of the components or entities. An entity could be a basketball team, and the components players. Similarly, an entity could be a robot, and the components pieces and characteristics of the robot. Typically the media is a smart card that capable of storing and transmitting electronically stored data.

### CROSS-REFERENCE TO RELATED APPLICATION

This application is a continuation-in-part of application Ser. No. 09/472,042, filed Dec. 27, 1999, entitled “A Computerized Trading Card System.”

### FIELD OF THE INVENTION

The field of invention is electronic games, and in particular electronic games that use read/writeable media.

The present invention is directed to smart trading cards used to play a game on a computer terminal. Specifically, smart trading cards are implemented using smart card technology to control access to a computer game program.

The hobby of collecting and trading trading cards based on sports figures, cartoon characters, and other persona has been enjoyed widely over the decades. A trading card may contain pictures of a famous person as well as information regarding that person. For instance, baseball player cards, which have been very popular in the U.S., include the picture of the baseball player as well as various statistics regarding the player's performance. The cards are issued in limited numbers, and over time may appreciate in value. Card owners may typically sell or trade the cards, at the enhanced value, for other cards or consideration. In other cases, users collect trading cards based on cartoon characters and may use them to either play board games against other cardholders or simply as a low value collecting experience.

Electronic video gaming devices have proliferated because of the popularity of personal computers, and because lower cost microprocessor based games have become economical. The games are constituted by computer programs executed on a conventional PC, or in some instances over a network connection that accesses video game software running on a remote computer that operates as a server. The computer software games may simulate such popular pastimes as baseball, football, basketball or golf. A user is presented with various selections under the game program control, enabling him to play the game by signaling a selection from his personal computer to the network computer. The combination of the playing card and computer games has been described in patents such as U.S. Pat. No. 5,689,561. These applications make trading cards an integral feature of a computer game, such as a floppy disk. The trading cards are constituted by a computer readable medium, such as a floppy disk, which transfers a key code to the computer system to unlock a companion CD ROM program that contains a game to be played.

The present invention seeks to improve these systems by providing a trading card in the form of a smart card that is read by a local computer. The local computer may, on its own, or via a network connection such as an Internet connection, access a computer game program.

### SUMMARY OF THE INVENTION

A system for collecting smart trading cards is provided that makes use of discrete items of read writable media, typically, a smart card storing information. The smart card is read by a local computer, and transfers security information to the local computer for permitting playing of a computer game. The system may be used in connection with a remote server that contains the computer game software. The trading card is packaged with various information displayed on the exterior of the trading card relating to the content of the card.

When the related computer game is implemented by a program running on a remote computer server, a security function is implemented in the smart card allowing the trading card holder to play the game from a remote computer connected to the computer server. Embedded security routines within the smart card microprocessor are read into a user's computer to establish a session with a computer game program running on the remote server.

Information from the game program server may be transferred to the trading card, representing the user's performance during playing of the game. The remote server can read the identity of the card and prevent two users from simultaneously playing the game using the card if a previous user trades or otherwise grants access to the smart card to a subsequent user.

In a preferred embodiment, the game comprises an entity having several components, and each item of media has data stored thereon that represents one or more components and/or properties of the components or entities. For example, an entity could be a basketball team, and the components individual players. Similarly, an entity could be a robot, and the components pieces and characteristics of the robot. Typically, the media is a smart card capable of storing and transmitting electronically stored data. The invention contemplates transferring components or properties from one item of media to another.

### BRIEF DESCRIPTION OF THE FIGURES

FIG. 1A is a front view of a smart trading card in accordance with the present invention;

FIG. 1B is the view of an opposite surface of the trading card shown in FIG. 1A;

FIG. 1C illustrates the architecture of a smart card used in accordance with a preferred embodiment of the present invention;

FIG. 2 illustrates the system for playing a game using the smart trading card;

FIG. 3 illustrates the flowchart used to install the base software for reading a smart card and executing a game using the smart card;

FIG. 4 illustrates execution of software when a game is played on the user's computing system;

FIG. 5 illustrates the execution for playing a game on-line from a remote server;

FIG. 6 illustrates a screen presented by the server for selecting a game to be played;

FIG. 7 illustrates the concept of a rotisserie baseball game utilizing smart trading cards;

FIG. 8 illustrates a screen presented for playing a game using smart trading cards;

FIG. 9 illustrates a subsequent screen presented when first learning to play the wizard's game of FIG. 8;

FIG. 10 illustrates the initial screen presented to the card holder for identifying the progress of play;

FIG. 11 illustrates a screen presented to the holder of the smart trading card for learning spells;

FIG. 12 illustrates a fresh screen for playing a game of Wizards against another wizard; and

FIG. 13 illustrates the first screen shown a participant in the game of Wizards.

FIG. 14 is a schematic of the system of the current invention.

FIG. 15 is flow chart showing one embodiment of the current invention.

FIG. 16 is flow chart showing one embodiment of the current invention.

### DETAILED DESCRIPTION

FIGS. 1A and 1B illustrate a smart trading card in accordance with the invention. The smart trading card 11 is contained in a package roughly the same size as conventional trading cards. On the exterior of the trading card 11 is a familiar figure, representing a sports figure or other personality of interest to collectors and traders of the trading cards. These may be as conventional as famous sports figures, such as baseball players, cartoon characters or other celebrities.

In the case of a smart trading card representing a sports figure, the picture of the sports figure is shown on one side as in FIG. 1A, and various statistics about the sports figure are included on the reverse side in the format of a conventional trading card, as shown in FIG. 1B.

The smart trading card II includes a row of connectors 13 that connect the smart card electronics through a card reader to a computer. In current smart card applications, the smart cards are connected via a computer network to a host computer, wherein data may be transferred to and from the smart card such as in banking applications. In accordance with the present invention the smart card may be used to transfer data by the user in possession of the smart trading card 11 to a local or a remote computer that is executing a game program.

The smart card is organized into a system shown in FIG. 1C. The processor 22 is connected to a data bus 20, which is connected to the contacts 13 of the smart card. A read only memory 21 includes information that will be used when a user attempts to play a game or otherwise use the smart card 11. A non-volatile RAM 23 is also provided that can receive information during the playing of a game, representing a score obtained by the user, or updated statistics concerning the player represented by the trading card. The information downloaded from game playing software running at a remote computer site may be written to the non-volatile RAM 23 where it is available for display by the user any time the user reads the smart card 11.

The smart card 11 includes a ROM 21, storing information specific to the card including a general card identification number 21(b), which identifies the card as belonging to a game to be played, or some other type of interactive activity. A card-specific number 21(a) is disclosed that is unique to the specific card and that is related to the general card identification number 21(b). When the smart trading card is read in the card reader, the remote computer that is playing a game will compare the card specific number 21(a) and general card identification number 21(b) to be certain that the card is valid from a known relationship that exists between the general card ID 21 (b) and the card-specific ID 21(a).

A security algorithm 21(c) is also stored within the ROM 21. The security algorithm represents data necessary to access the game being run on the remote computer server. The security algorithm is uploaded to the remote computer server where it is combined with information running on the remote computer server to enable access to the game playing software. Unless the remote computer server receives the security information access to the game playing software is denied.

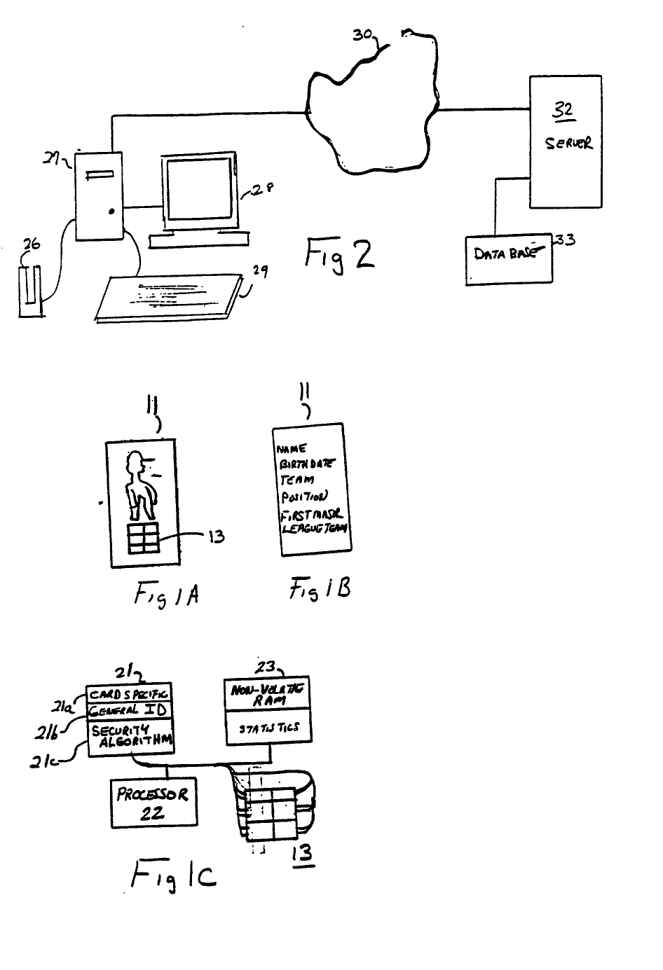

A system for using the smart trading card 11 is shown more particularly in FIG. 2. FIG. 2 illustrates a computing facility 25 at the user's location for accessing the smart trading card 11. The computing facility includes a smart card reader 26 connected to a port of processor 27. A display 28 and keyboard 29 are provided to permit the interactive playing of a game related to the contents of the trading card 11.

A user's computing facility 25 is used as terminal equipment for computer game software being executed on a remote server 32. The remote server 32 is connected via a network 30, which may be the Internet, through appropriate interfaces to the computing facility 25.

The computing facility 25 includes certain base systems software necessary for communicating with the smart trading card II as well as the remote server 32.

The base system software for the computing system 25, which may be downloaded from the server 32, includes a card reader interface. Additionally, card related information for verifying the card is downloaded along with graphic elements that are presented on the display 28 identifying a card type read from the card reader 26. The foregoing system, which is capable of reading the smart trading cards and writing to the cards from the server 28, provides an interactive game capability for the holders of the smart trading cards 11.

In the system of FIG. 2, all of the base system software may be downloaded from the remote server 32, or may be resident in the processor 27 from a CD ROM that is supplied in a start-up kit for those who collect and utilize the smart trading cards 11.

The sports card 11 stores invariable information about the player, which does not change, which is stored in the ROM 21. Additionally, variable information included in the non-volatile RAM representing a player data file may be subsequently updated with various statistics from the computer game server. These statistics may relate to the actual performance of the player represented by the trading card. Thus holders of the card may evaluate the performance of a player and use the information for making trading decisions.

The protocol for data transfer between the smart card based smart trading card 11 and a remote server 32 containing a computer game program will conform to ISO standards. The ISO standard control can retrieve information from the smart card, and upload the data upon request of the computer game running on server 32. Further, using the ISO standards, updated statistics for a player may be transferred from the server 28 to the smart trading card non-volatile RAM 23.

The computer program running on server 32 includes a database 33 for maintaining game information. The database 33 may include the following four tables:

Players TABLE: This table contains information about each player, including the player's ID, the game ID, the type (i.e., baseball, basketball, etc.), the name of the player, a graphics image of the player, other personal statistics of the player, whether he bats left- or right-handed, etc., the birth date and the position played by the player.

Positions TABLE: The positions table maps a number (Position ID) to a position as an abbreviation. For example, the position of first base in an interactive baseball game played using the smart trading card is set with a specific reference number, i.e., first base may be symbolized by the number “2”.

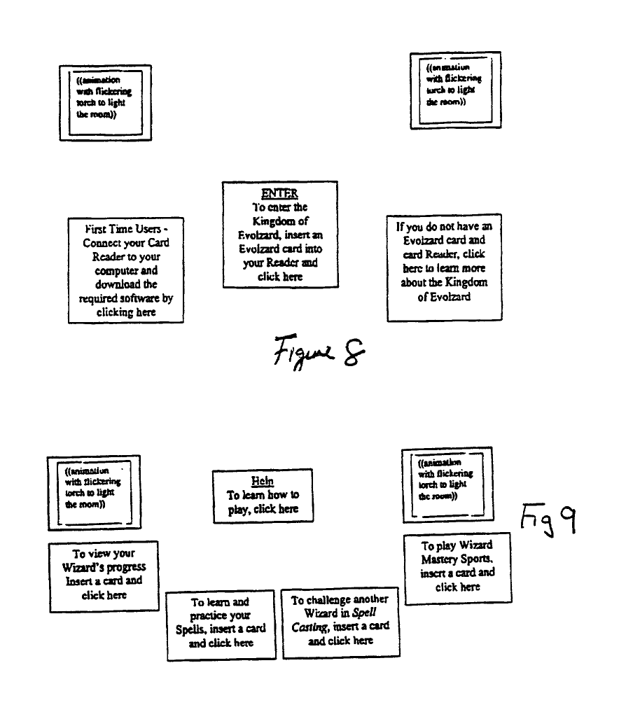

Teams TABLE: This table contains information about a team that the user is creating in a baseball interactive game. It includes a card ID, the name of the team, type of team, points scored and players on the team. During the process of playing a rotisserie-type baseball game, as will be described with respect to FIGS. 6 and 7, a team comprises each of the players represented by a smart trading card 11.

Users TABLE: This table contains information about a particular player of the interactive game, such as his first name, last name, e-mail address.

Card TABLE: This table contains information about all the smart trading cards that are being used to play a game, i.e., the card type, card ID, player ID, etc.

The foregoing database is used to play an interactive baseball game, and anticipates that information about the players will be updated on a regular basis, representing the real life statistics of players identified by the smart trading cards. The database is, therefore, updated on a frequent basis, as the real life statistics associated with the players becomes the means by which to determine a score.

The present invention, which is advantageously implemented on a remote server connected via an Internet connection to a local user, may also be loaded directly on a local user's computer system 25. However, it is considered advantageous to operate the game over the Internet, through a remote server that can be updated to provided a variety of game options for the users of the smart trading cards.

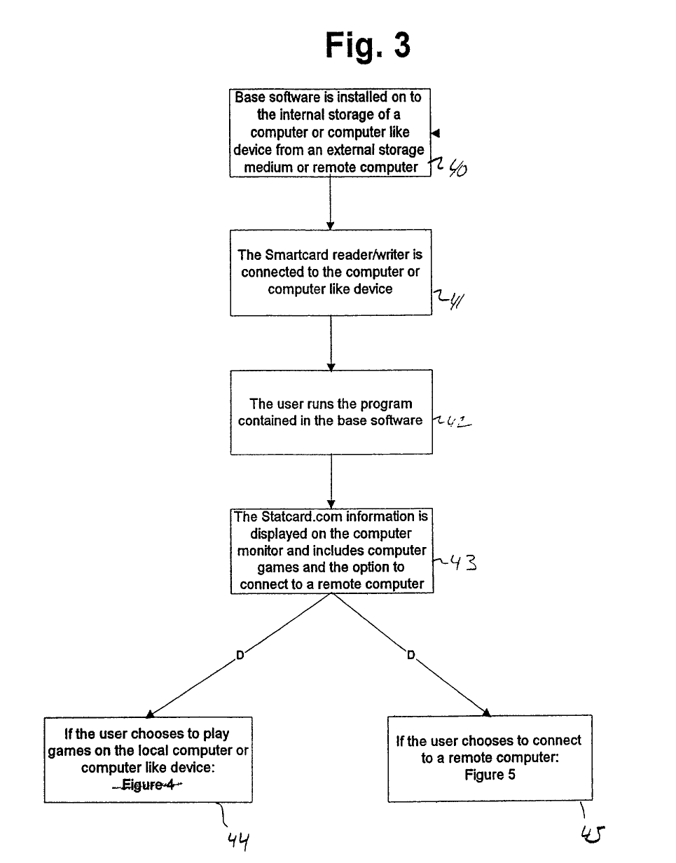

FIG. 3 illustrates the execution sequence for playing a computer game. The game software on the CDROM in the start-up kit is installed on the internal storage of a computer serving as the user's home computer computing system. Alternatively, the base software can be delivered to the user through the Internet from a web site maintained by the trading card issuer. The base software contains computer games and drivers that allow the local computer to recognize and communicate with the smart card reader/writer 26, and allows the local computer system 27 and remote computer server 32 to read and write information to the smart card. The smart card reader/writer 26 is connected to the computer port 27 in step 41, and the user runs the base software programs in step 42. Execution of the base software results in the trading card information being displayed on the computer monitor 28 and includes computer games and the option to connect to a remote computer on which a computer game is executed.

The user is presented with a decision as to whether or not a game is to be played on a user's computing system, or whether it is to be played on a remote computer such as server 32.

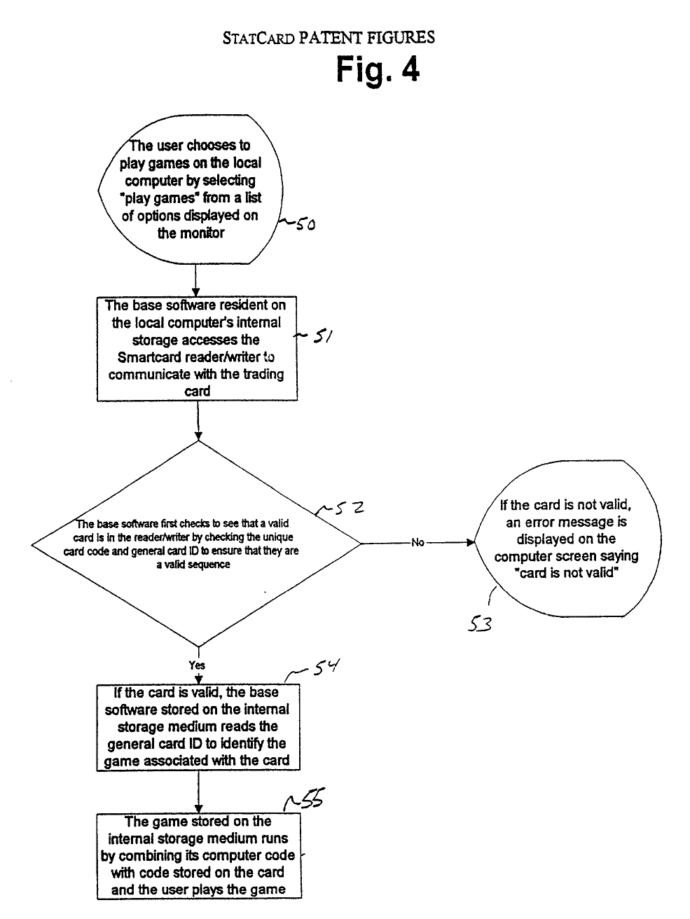

If the game is played locally on the user's computing system 25, then execution proceeds as shown in FIG. 4. FIG. 4 is entered in step 50 by the user selecting a game option through conventional point-and-click controls in step 50 on the user's computer system. The base software resident on the local computer's internal storage accesses the smart card reader/writer 26 to establish a communication session with the smart card. The base software running in the user's computer 27 determines in decision block 52 whether or not a card is being read by the reader/writer 26 by checking the unique card code and general card ID. As these two numbers are related for a given card type, it is possible to decide whether or not a fraudulent card might be inserted in the card reader 26. In the event the card cannot be validated by comparing the general and specific card identification numbers, a message is displayed in step 53 that the card is not valid.

Even if the card is determined to be valid, the base software reads the general card ID to identify which game is associated with the card. The game stored on the internal storage medium selected from the “play games” option of step 50 then determines from the stored algorithm code read from the smart card is combined with the computer code retained within the game software. Once the game software validates the combination, access to the game is given to the user.

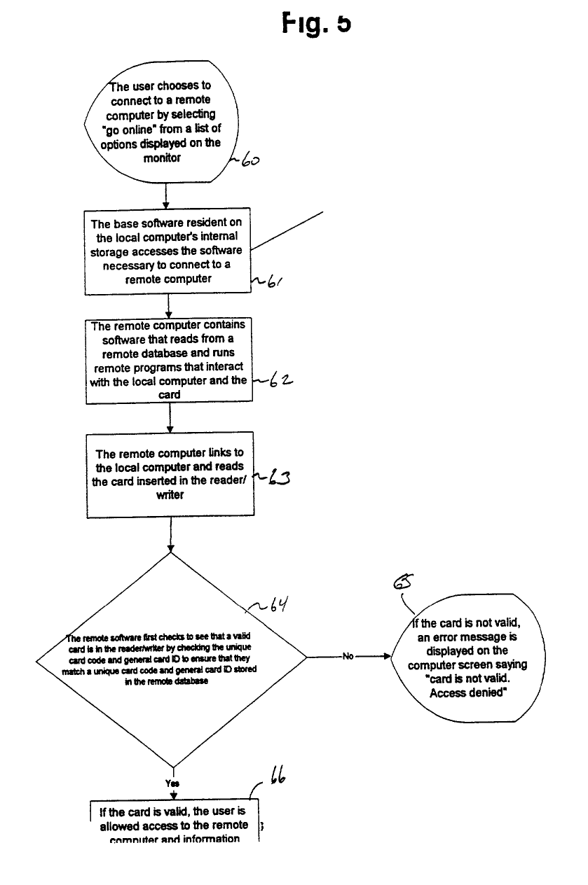

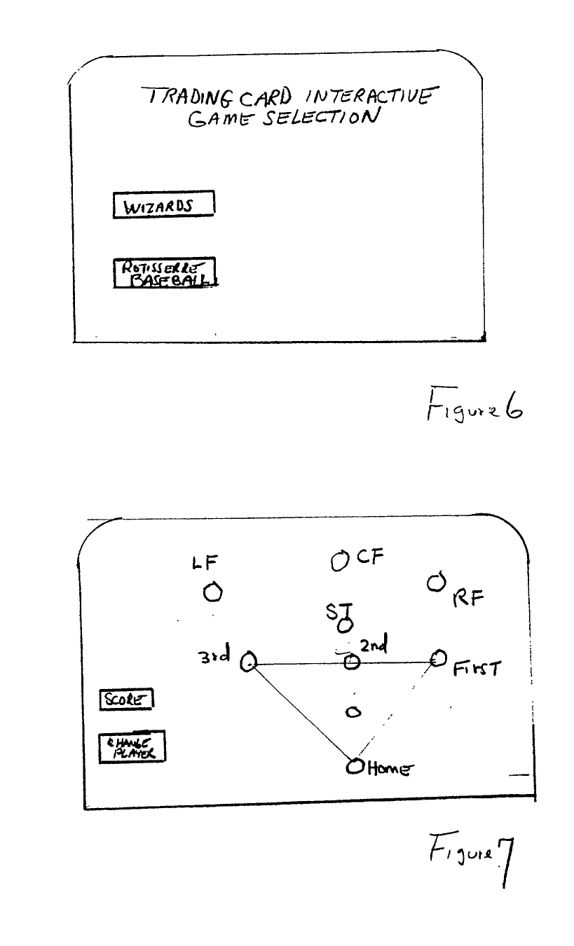

FIG. 5 represents a similar scenario wherein a user chooses to play a game on-line, by contacting a web site on server 32 to gain the game software. The base software resident on the local computer's internal storage includes the software necessary to connect to the remote computer in step 61, once the appropriate icon has been selected to go on-line. The local base software contains a web browser program and instructions to run a computer modem. Once a connection is made to the remote server 32, software running on server 32 loads a game program for play. The remote computer links to a user's computer and reads the smart card when inserted in the smart card reader/writer 26 in step 63. As in the stand-alone version of the game, the remote software first checks to see that a valid card has been read by checking the unique card code and general ID to ensure that they match the unique card code and general card ID stored in the remote database seen in box 64. Further, in step 66 the security algorithms are read from the smart card 26 by the remote server 32 to validate that the user is in possession of a valid trading card, and the game is permitted to run. The security algorithm derived from the smart card is combined with related security data contained in the game software as a protection against counterfeit trading cards.

Rotisserie/Fantasy Baseball

The smart trading cards 11 may represent players in a baseball game. The user collects nine cards, each card representing one player for the nine positions on the baseball team. A user connects to the remote server 32 by selecting from an icon (shown in FIG. 6) on his local computer the “rotisserie baseball” icon. The base system software loaded on the user's computer 25 will execute a connection sequence for connecting the modem of processor 27 to the Internet and remote server 32.

Once the server 32 responds and a connection is established, the server 32 would read in sequence each of the nine smart trading cards of the user. By inserting each individual card into the reader 26, data from the trading card's ROM 21 is uploaded to the server 32, and the server 32 forms a team consisting of the user's nine players identified by each smart trading card and displays the team members in a subsequent screen shown in FIG. 7. During the process of setting up the teams, the server 28 running the game software would perform a check to make sure that other users are not using the same smart trading cards. The remote server 28 maintains a database of the card-specific numbers, and prevents the formation of a team using the same trading card as long as the card remains active.

The general ID stored in the ROM 21 is checked by the game playing software running in server 32 to make sure that it corresponds to an appropriate card-specific code before forming a team. The server 32 also checks the card-specific code with respect to the general card ID to make certain that the two are related, to avoid any attempt at counterfeiting smart trading cards.

Once the team has been assembled, the user is downloaded a graphic, such as that shown in FIG. 7, representing each of the players on the field. The system operator enters the real life statistics for each of the players on the computer server 32 running the game software on a regular basis. A score is kept by forming a composite of the individual statistics of the players of a team, i.e., runs, errors made, hits and catches. Strikeouts and walks subtract points from a team. Game players may trade playing cards with other game players to enhance their score by acquiring cards representing players whose recent performance will raise the overall team score. Clicking on the change player icon and then reading the new trading card in reader 26 effects changing the player.

The overall composite score of each of the teams is viewed on the user's computer screen 28 by clicking on the score icon. The various statistics used to derive the score are also displayed for each team.

The statistics of each individual player that were used to score the game may also be downloaded and written to the smart trading card non-volatile memory 23. Thus, the information about the player may be available for display on the computer display 28 the next time the user reads the smart trading card 11. If the user wishes to trade the card to another user, he must first deactivate the card by accessing the game playing software loaded on the server 32. The server 32 when it receives a command form the cardholder to remove the card from play, will note the status of the card as inactive in the server database 33 by writing to the field dedicated for this status in the record containing the card-specific identification number. Thus, a new user, when he attempts to use the card in a rotisserie-based ball game, will enter the card and player into the game. Unless the system has deactivated the card at the request of the user, a subsequent attempt to use the card to form another team will be refused by the game playing software running on server 32.

Wizards and Spell Game

Another illustration of another game type that can be implemented using the smart trading cards and a related program on the computer server 32 will be described.

The smart trading cards' surfaces include an image of a fully evolved wizard. The opposite side of the smart trading card contains the wizard's name, spells the wizard must master, arch enemies of the wizard and a wizard master score that the wizard must achieve in order to play against another wizard. Stored within the smart trading card 11 is information related to the skill level of the wizard. As the player learns various spells and defeats any wizard's enemy, and masters the wizard's skills, the non-volatile memory 22 will be written with information relating to the progress of the player. Each time that the smart trading card 11 is inserted into the card reader, the stored information is displayed on the display 28.

Play begins when the card is read to establish a connection between the local computer 25 and the server 32 having the game software. The base software installed into the viewer's local computer 27 produces an icon on the user's desktop. By double clicking on the icon, the web site for playing the game is accessed, and the user is presented with three choices concerning the game.

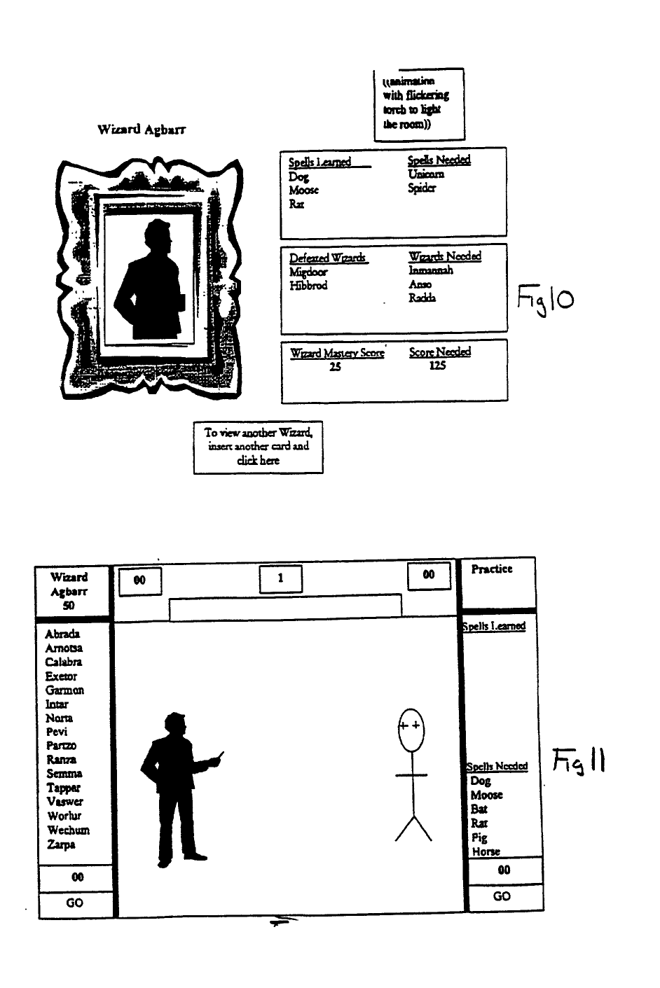

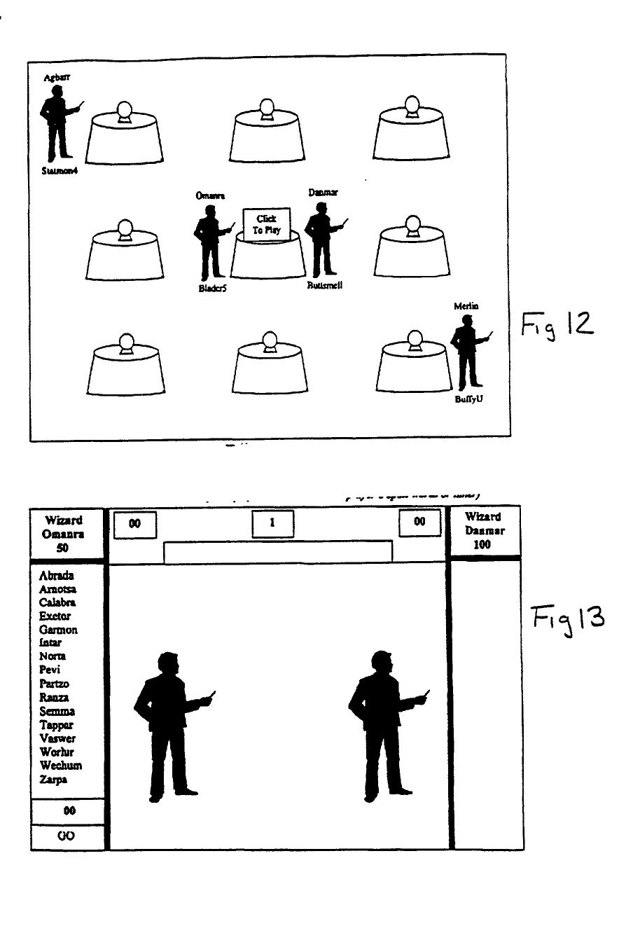

FIG. 8 illustrates the three choices presented to the user. When the user enters the kingdom of the Evol Wizard, the second screen shown in FIG. 9 is presented to the user. When the user uses the smart trading card for the first time, or has not achieved various wizard evolution events, the image of the wizard will look like a child, not like the image on the smart trading card. The display 28 will also contain vital spells, arch enemies, and the wizard's master score, as shown in FIG. 10 The vital spells that the player has mastered and arch enemies defeated will be highlighted so that the player will know which events still need to take place in order to fully evolve and win a game. In addition, a current wizard mastery score is displayed beside the goal score as player information.

The game starts by having the wizard master certain spells. To accomplish this, the wizard will enter the Kingdom by clicking on the appropriate icon of FIG. 9 to learn and practice spell making. The user is provided with a screen, as is shown in FIG. 11, with a list of magic words and a list of animals he must learn using the correct combination of magic words. If a user chooses a combination and makes one of the requisite animals, a simulated poof of smoke followed by a simulated disappearance of a displayed animal will appear on the screen. The name of the animal will be removed from the “spells needed” list and put on the “spells learned” list of FIG. 10. If the combination of words selected do not constitute the animal, sparks will fly and a strange animal will appear, i.e.; a dog with a rabbit's ears.

Thus, a player shown on the left of the screen changes the person on the right of the screen into an animal by invoking the correct word. If the wrong word is selected, a puff of smoke is generated, and sparks are displayed as well as a strange animal such as a dog having moose antlers.

When the user has learned all of the requisite spells, he gets a diploma screen, and he further moves on to battle other wizards.

Having learned the requisite spells, the user can battle with another wizard. The set-up for a battle between wizards is shown in FIGS. 12 and 13. In the first step, a room is set up having a group of tables, each with its own number. At a table is a crystal ball, and a user clicks to the side of a table where no one is standing. The wizard's name and picture will appear where the user clicks. In addition, the user's name will appear below the wizard. When a second user clicks on the other side of the table, that user's wizard's name, picture and user name will appear (all pictures of the wizard will be the same view). In addition, a parchment paper will appear over the crystal ball that says “Click here to play.” When both players have clicked on the parchment, a new window comes up with a courtyard and a wizard on either side, as shown in FIG. 13. In the event a player pulls out early, a loss is recorded on the user's smart playing card by writing to the non-volatile memory 23. The courtyard where the battle takes place will be identical to the courtyard in which the spells were learned.

Each user to the game is presented with a screen such as shown in FIG. 13, which shows his list of words on the left, constituting spells to be cast. The list of his opponent's spells will be obscured. The spell words will change from each player as each player casts a spell.

When a player's turn to cast a spell occurs, and when a wizard casts a spell, the wizard turns to an animal and a score is made. A set of five rounds per game will be utilized in a preferred embodiment, and after five rounds the one who has correctly cast the highest number of spells wins the game.

Entity/Component Combinations

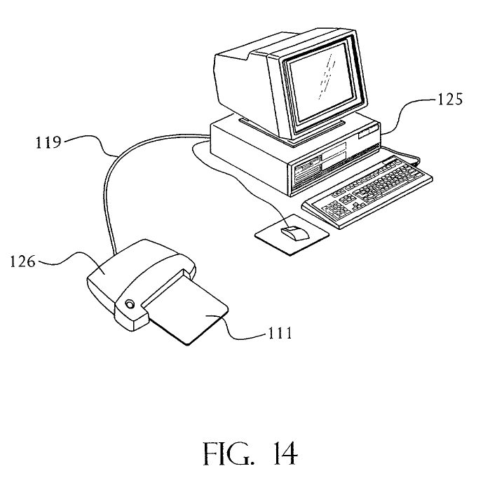

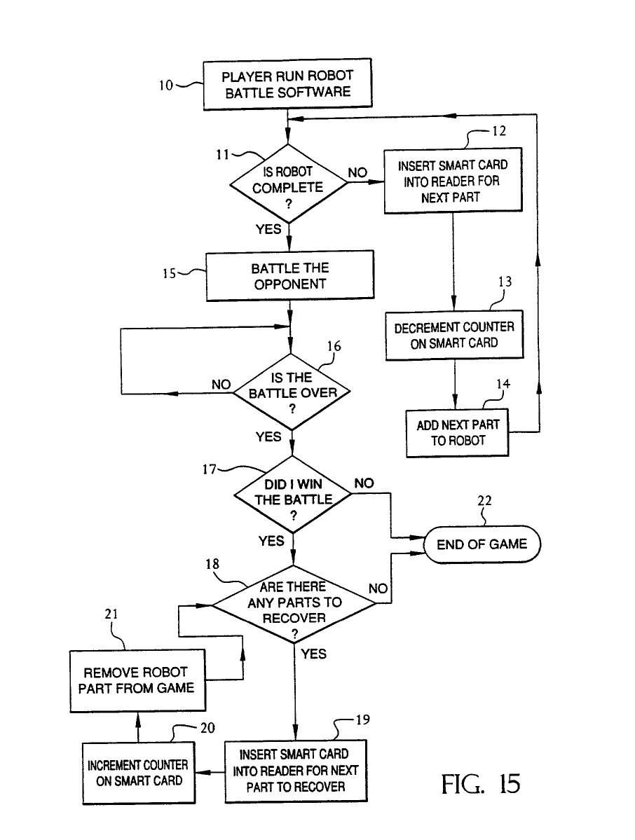

FIG. 14 shows a schematic of a system that permits transfer of components or properties of an entity from one item of media to another. The system comprises an instrument 111 capable of storing electronic data for later retrieval, a device 126, and a computer 125 (these correspond to the card 11, reader 26 and computing facility 25 discussed previously). The instrument 111 cooperates with a device 126 for reading data from and writing data to the instrument. The device 112 is connected to a personal computer 125 by means of communication link 119. The computer allows a user to play a game directly on it, or it may be connected to other networked computers that have gaming software loaded thereon. The instrument 111 could be a smart card (as shown in the FIG. 1), a three dimensional object, a diskette, etc. If the instrument 111 is a smart card, device 126 is a reader/writer known in the art. To simplify the description that follows, it is assumed that instrument 111 is a smart card, but other instruments can be used.

The smart card 111 stores and transmits electronic data. Typically the smart card has an embedded chip for storing and retrieving the information, although other storage and retrieval means are possible. Smart card 111 is shown inserted into a first device 126 that reads information stored on the card, and also can write information to the card.

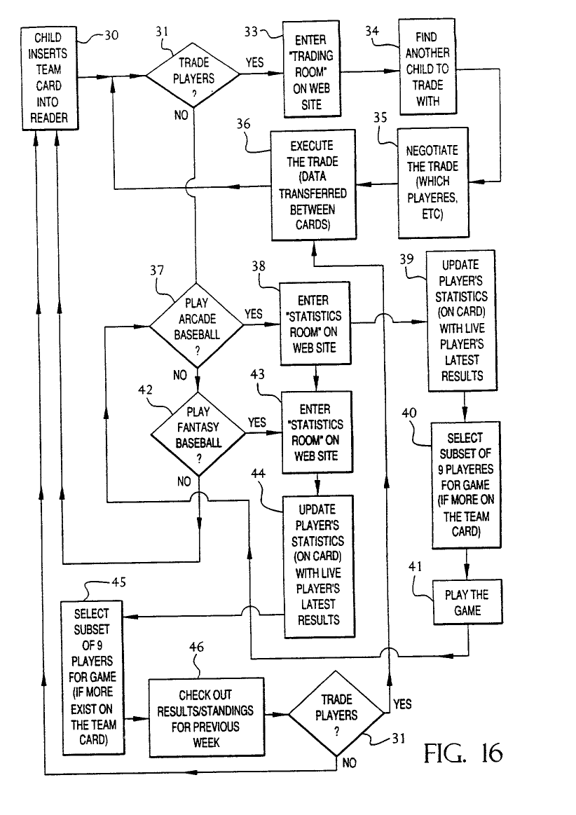

One example of how the game works is shown in FIG. 15. The game begins when a player runs the Robot Battle Software 210 and selects an opponent (either any other player or computer controlled). The player builds a robot (the entity) using smart cards containing the components or attributes 211. The player inserts smart cards into the Reader one at a time 212 while the Battle Software displays the progress of the robot being built. As each piece is added to the robot, a counter or power score is decremented on the smart card 213 if it is a limited use card, and that particular piece is added to the robot display 214. At a minimum the player must have a set of legs or wheels, a body, and a head. Additional pieces include various detection units, armor plating, etc.

After the players have built their robots, the battle begins (215, 216). The battle follows a set of rules designated by the software designers. For example, properties of the robot components might include:

Tank Treads on Rough Ground have speed of 10 and stability of 100

Clawed Feet on Rough Ground have speed of 25 and stability of 25

Laser Rifle power is reduced by 25% against Reflective Armor

The battle will progress for a set amount of time or until one Robot is the clear winner. When the battle is over 217, the winner has the ability to reclaim parts from the robots in the battle 18. Technically, this is done by transferring data regarding the components to the winner's card. Either the winner can claim a component of a similar nature to the component he already has (exchanging a Tank Tread component for an Iron Foot component), increase the number of same components on a card (the card could be incremented to have two Tank Treads), or the user might be allowed to insert a blank card to salvage the extra component.

For example, the winner may be required to insert the appropriate smart card corresponding to the part desired to be claimed into the Reader 219. If the component on the robot (i.e., a Tank Tread) is an exact match for the smart card, the counter or power score on the card is incremented 220. Otherwise it is possible to enhance or replace the part. For example, if the losing robot had Tank Treads, and the winning player inserted an Iron Foot smart card, the Iron Foot smart card could become a Tank Treads card or an Iron Foot with Extra Grip. After being scavenged, that Robot part is removed from the battle ground 221. Finally, a blank card could be inserted to scavenge components if the rules of the game so permitted.

FIG. 16 shows an alternate version of the game using sports teams and players. In this system, each smart card collectible/trading card represents a team of players (e.g. 5 players for a basketball card or 9 players for a baseball card). The team functions as a whole when the card is used during games such as action/arcade, strategy, rotisserie leagues etc. Each player on the team, however, is a separate entity and may be traded or replaced during interactions with other collectors.

For purposes of this description, an example will be described in details that uses a baseball game and associated Team Cards, but this is applicable to many games not limited to major league sports. This system comprises a set of smart card Team Cards, a web site, and two levels of game play. Each Team Card represents a team of 9 baseball players (pitcher, catcher, shortstop, 1st, 2nd and 3rd base, and 3 outfielders) not necessarily corresponding to actual major league teams.

After attaching the Reader to his or her Computer, a user may then insert the Team Card in the Reader and visit the Smart Baseball web site. From within the web site, the user may view statistics about each of their players and update the information stored on the card. With the current statistics, the user may participate in the first level of game play, rotisserie (or fantasy) baseball. If the players on the cards correspond to real players, as the real baseball players do better, the Team Cards containing those players gain more points. A weekly listing of Team Card rankings will be displayed. To enhance their Team Card, a person would be allowed to trade individual or multiple players with other players over the Internet in specially designed “trading” rooms on the Smart Baseball web site. Other incentives to trade or keep players may be periodically made available on the web site as well. These could include bonus points for any Team Card that contained a certain players during the past week or bonus points for anyone that made two or more trades in the past three days.

A second level of game play would be available to Team Card holders that would allow them to play an arcade style baseball games using the players on the Team Card. The abilities of the players on the card could reflect the current statistics of the corresponding live player combined with the skill of the user playing the game.

The user begins by 30 inserting a Team Card in the Reader and opening the associated web site for this card series. From the web site, the user will have many options, one of which is to decide 31 whether to trade any of the players on the Team Card.

If the user wants to trade players 233, he will enter a special area of the web site dedicated to trading players called the “Trading Room”. Once within this “room”, the user will see a list of others willing to make trades. He will select someone (Peer at a remote computer system) 234 to trade with and negotiate the trade 235. The negotiations will take place via a chat-like interface similar to the following:

User: selects player to trade and clicks “post trade”

Peer: selects player to trade and clicks “post trade”

User: denies Peer's player and requests an alternate player

Peer: selects alternate player to trade and clicks “post trade”

User: accepts trade

Once the trade is accepted, 36 the software on the web site will initiate a secure session between the cards in the readers and perform the necessary data transfer to remove and add players to the cards.

If the user wants to play the arcade-style game 237, he will first enter a statistics room 238 where the most current results of the live players will be loaded onto the Team Card 239. If the Team Card contains more than 9 players (for baseball), the user will select the 9 to play with at this time 240. When the game play begins 241, the players on the Team Card will perform based upon the statistics loaded in step 239. For example, if Roger Clemens has had a bad week of pitching, then the “virtual Roger Clemens” will not pitch as well as before. It is also possible to update the players' statistics based upon the skill of the user playing the game. In the above example, if the user through playing the arcade game pitched very well, the “virtual Roger Clemens” would get “better” at pitching.

If the user wants to play fantasy baseball (rotisserie league) 242, the latest live players' statistics are downloaded to the Team Card 243 and 244 as in the arcade steps 238 and 239. The user can also modify the team of 9 players 245 that will be active for the following week (when there are more than 9 players on the card). As in standard fantasy team games, a team gains points based upon how the individual live players have performed over the past week. The user may 246 view how this team ranks compared to all others participating in this fantasy league. Finally, the user may trade players 231 to enhance his team for the following week.

The common theme between the baseball and robot games is that each game requires an entity (robot or team) that has several components (clawed feet, laser rifle, or individual players). Each card contains at least one of these constituent parts, and the parts are combined in the computer to create the entity during game play. Other entity/component combinations such as party/character and machine/part are possible, and further variations would be obvious to one of ordinary skill in the art.

The foregoing description of the invention illustrates and describes the present invention. The invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention Accordingly, the description is not intended to limit the invention to the form disclosed herein. In addition, it is intended that the appended claims be construed to include alternative embodiments.

What is claimed is:

1. A system using a trading card for interactive entertainment, comprising:
an embedded-chip trading card representing an entity having at least one attribute and including a memory containing identification data, gaming data describing the entity and the at least one attribute, and access software;
a local computer system;
a remote computer system including trading card information;
a communications network connecting said local computer system to said remote computer system;
a card reader/writer coupled to the local computer system for reading and writing to said embedded-chip trading card and transferring said identification data, said gaming data, and said access software via said local computer system and communications network to said remote computer system for processing said identification data, said gaming data, and said access software to enable access to said remote computer system for interactive entertainment, said remote computer system including software for enabling a user to selectably alter the gaming data in said trading card memory to alter the at least one attribute of said entity represented by said trading card.

2. The system of claim 1, wherein the entity is a sports team and the at least one attribute is a player on the team.

3. The system of claim 1, wherein the remote computer system allows gaming data describing the at least one attribute to be selectably transferred from a first trading card to a second trading card.

4. The system of claim 3, wherein the first trading card is used with a local computer system at a first location and the second trading card is used with a local computer system at a second location separate from the first location.

5. A system for using more than one instrument cooperatively in a game having at least one entity having more than one component, the system comprising:
a) a first instrument usable by a customer, the instrument capable of storing a first component in electronic form for later retrieval;
b) a second instrument usable by the customer, the instrument capable of storing a second component in electronic form for later retrieval;
c) a device for reading data stored on an instrument and writing data to the instrument, the data representing a components; and
d) a computer for running the game, the game using game data during the game, the game using an entity having more than one component.

6. The system of claim 5, wherein the instruments are smart cards.

7. The system of claim 5 wherein the entity is a team and the components are players.

8. The system of claim 5 wherein the entity is a machine and the components are parts of the machine.

9. The system of claim 5 wherein the entity is a machine and the components are parts of the robot.

10. The system of claim 5 wherein the entity is a machine and the components are characteristics of the robot.

11. The system of claim 5 wherein the entity is a machine and the components are parts and characteristics of the robot.

12. The system of claim 5 wherein the entity is a party and the components are characters in the party.

13. The system of claim 5, wherein the first component stored on the first instrument can be transferred to the second instrument.

14. The system of claim 13, wherein the first component is removed from the first instrument following the transfer.

15. The system of claim 6, wherein the first component stored on the first instrument can be transferred to the second instrument.

16. The system of claim 15, wherein the first component is removed from the first instrument following the transfer.

17. A system for using more than one instrument cooperatively in a multi-player game having at least one entity per player, each entity having more than one component, the system comprising:
a) a first instrument usable by a first player, the instrument capable of storing a component in electronic form for later retrieval;
b) a second instrument usable by the first player, the instrument capable of storing a component in electronic form for later retrieval;
c) a third instrument usable by a second player, the instrument capable of storing a component in electronic form for later retrieval;
d) a fourth instrument usable by a second player, the instrument capable of storing a component in electronic form for later retrieval;
e) a device for reading data stored on the instruments and writing data to the instruments, the data representing components; and
f) a computer for running the game, the game using game data during the game, the game using the entities having more than one component.

18. The system of claim 17 wherein the instruments are smart cards.

19. The system of claim 17 wherein the entity is a team and the components are players.

20. The system of claim 17 wherein the entity is a machine and the components are parts of the machine.

21. The system of claim 17 wherein the entity is a machine and the components are parts of the robot.

22. The system of claim 17 wherein the entity is a machine and the components are characteristics of the robot.

23. The system of claim 17 wherein the entity is a machine and the components are parts and characteristics of the robot.

24. The system of claim 17 wherein the entity is a party and the components are characters in the party.

25. The system of claim 17, wherein the first component stored on the first instrument can be transferred to the second instrument.

26. The system of claim 25, wherein the first component is removed from the first instrument following the transfer.

27. The system of claim 18, wherein the first component stored on the first instrument can be transferred to the second instrument.

28. The system of claim 27, wherein the first component is removed from the first instrument following the transfer.
